(19) United States
(12) Patent Application Publication
(10) Pub. No.: US 2025/0033449 A1
(43) Pub. Date: Jan. 30, 2025

(54) REAR-WHEEL DRIVE SYSTEM FOR A MOBILITY VEHICLE

(71) Applicant: VALEO EMBRAYAGES, Amiens (FR)

(72) Inventors: Guillem Enjalbert, St Quentin Fallavier (FR); Anthony Puget, St Quentin Fallavier (FR)

(73) Assignee: VALEO EMBRAYAGES, Amiens (FR)

(21) Appl. No.: 18/713,976

(22) PCT Filed: Oct. 24, 2022
(86) PCT No.: PCT/EP2022/079636

§ 371 Date: May 28, 2024

(30) Foreign Application Priority Data
Nov. 26, 2021 (FR) 2112614
Nov. 26, 2021 (FR) 2112615

(51) Int. Cl. B60K 1/02

(52) U.S. Cl. CPC B60K 1/02; B60Y 2300/60; B60Y 2400/20

(57) ABSTRACT

A rear-wheel drive propulsion system for a mobility vehicle includes at least two electric machines and two transmission devices. Each machine is associated with one transmission device and operates independently of one another.

The present invention relates to a propulsion system for a mobility vehicle, and more particularly to a propulsion system for a mobility vehicle comprising four wheels, and which is situated at the rear.

Rear-wheel drive propulsion systems for single-seater mobility vehicles comprising four wheels are already known. These vehicles are known as cross cars. The propulsion unit used in the propulsion system is usually a combustion engine.

The disadvantage with these systems stems from the fact that the presence of one single propulsion unit for two wheels entails a mechanical differential. In addition, the use of a combustion engine makes the vehicle heavier and generates problems of pollution and the risks of a fire breaking out, during use of these vehicles on circuits, connected with the presence of fuel.

The object of the present invention is therefore to overcome one or more of the disadvantages of the devices of the prior art by proposing an improved rear-wheel drive propulsion system for a mobility vehicle.

For that purpose, the present invention proposes a rear-wheel drive propulsion system for a mobility vehicle, comprising at least two electric machines and two transmission devices, each machine being associated with one transmission device and operating independently of one another.

In that way, the correct amount of torque can be delivered to each wheel independently of one another. There is more effective transmission of power to each wheel.

According to one embodiment of the invention, the power of each of the electric machines is equal to 25 kW.

According to one embodiment of the invention, the electric machine is a 48 V machine.

According to one embodiment of the invention, the transmission device comprises a reduction stage comprising an elastic, notably ribbed, belt and two pulleys.

According to one embodiment of the invention, the rear-wheel drive propulsion system comprises a 48 V/12 V (DC/DC) voltage converter.

According to one embodiment of the invention, the rear-wheel drive propulsion system comprises a motor control unit which controls all of the electrical and electronic elements of the mobility vehicle.

The invention also relates to the use of the propulsion system according to the invention in a mobility vehicle comprising at least 3 wheels.

The invention also relates to a mobility vehicle comprising a propulsion system according to the invention.

According to one embodiment of the invention, a first electric machine operates a first rear wheel and a second electric machine operates a second rear wheel.

The invention also relates to a cross car equipped with a propulsion system according to the invention.

Further aims, features and advantages of the invention will be understood better and will become more clearly apparent from reading the description given below with reference to the appended figures, which are given by way of example and in which:

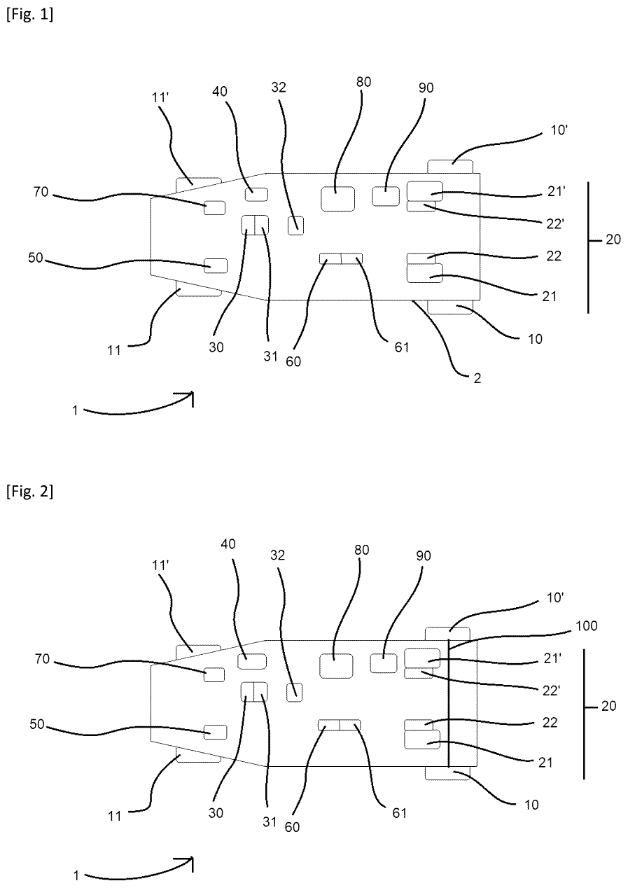

FIG. 1 is a schematic depiction of a mobility vehicle according to a first alternative embodiment of the invention,

FIG. 2 is a schematic depiction of a mobility vehicle according to a second alternative embodiment of the invention.

The invention illustrated in [FIG. 1] relates to a rear-wheel drive propulsion system 20 for a mobility vehicle 1. The mobility vehicle 1, also referred to as an automotive vehicle, comprises at least three wheels. According to one embodiment of the invention, the mobility vehicle 1 comprises four wheels 10, 10′, 11, 11′.

Two wheels 11, 11′ are positioned at the front of the vehicle 1 and two wheels 10, 10′ are positioned at the rear 2 of the vehicle 1. The front and the rear of the vehicle are defined with reference to the standard direction of travel of a mobility vehicle. That means that the front of the vehicle is the part that is at the front when the vehicle is moving in a forward gear.

The propulsion system 20 to which the invention relates is configured to be positioned at the rear 2 of a mobility vehicle 1. More specifically, the propulsion system 20 is configured to be positioned at the two rear wheels 10, 10′ so as to be able to drive same.

In the context of the invention, the propulsion system 20 is formed by at least two electric machines 21, 21′ and two transmission devices 22, 22′.

More specifically, the propulsion system 20 is made up of two electric machines 21, 21′ each operating one rear wheel 10, 10′. What that means is that a first electric machine 21 operates a first rear wheel 10 and a second electric machine 21′ operates a second rear wheel 10′.

According to one embodiment of the invention, the propulsion system 20 is made up of two electric machines 21, 21′ each independently operating one rear wheel 10, 10′.

In that way, the correct amount of torque can be delivered to each wheel independently of one another. There is more effective transmission of power to each wheel.

According to one embodiment of the invention, the electric machine 21, 21′ comprises a stator surrounding a shaft rotor mounted on a shaft and an electronic assembly of the inverter type. This machine is intended to be coupled to a transmission device 22, 22′. The machine 21, 21′ is then able to operate in alternator mode in order notably to supply energy to the battery and to the on-board network of the mobility vehicle, and in motor mode to contribute to the propulsion of the mobility vehicle. According to one embodiment of the invention, the power of the electric machine 21, 21′ is between 18 kW and 50 kW. According to one embodiment of the invention, the power of each electric machine 21, 21′ is equal to 25 kW.

According to one embodiment of the invention, the electric machine 21, 21′ is a 48 V machine.

In the context of the invention, each electric machine 21, 21′ is coupled to a power transmission device 22, 22′, without the differential function, providing the drive for the wheels of the vehicle. The vehicle 1 thus comprises two transmission devices 22, 22′.

Each transmission device 22, 22′ comprises a reduction stage comprising an elastic, notably ribbed, belt and two pulleys. The elastic belt is configured to transmit torque to at least one wheel of the automotive vehicle.

More specifically, the torque transmission device 22, 22′ is able, on the one hand, to receive torque originating from the electric machine 21, 21′ and, on the hand, to transmit torque to at least one rear wheel 10, 10′ of the vehicle. The fact that there is one transmission device for each of the rear wheels enables the torque to be transmitted to each of the wheels effectively and independently.

According to one embodiment, the transmission device 22, 22′ comprises a reduction stage comprising two pulleys, the elastic belt is mounted on the two pulleys and is designed, particularly together with an auxiliary reducer, to achieve a conversion ratio of between 3/1 and 28/1.

According to one embodiment of the invention, the propulsion system 20 comprises a 48 V/12 V (DC/DC) voltage converter 90.

According to one embodiment of the invention, the propulsion system 20 comprises a motor control unit 80 which controls all of the electrical and electronic elements of the mobility vehicle. More specifically, the control unit 80 acts as the interface with the instrument panel, the converter 90 and the electric machines 21, 22′.

This unit 80 is able to monitor faults with all of these electrical and electronic elements, manage the positive and negative torque and control the driving mode (neutral, drive, reverse).

The energy needed for the operation of the propulsion system is supplied by a rechargeable battery 40. The battery is recharged via a cable and a connector suitable for connecting to a mains outlet or charging terminal. The energy from the battery is distributed via the converter.

According to one embodiment of the invention, the battery is a 12 V battery.

The invention also relates to a mobility vehicle 1 comprising a propulsion system 20 according to the invention.

Such a vehicle comprises a chassis on which there is mounted bodywork inside which there is a seating means for at least a driver.

According to one embodiment of the invention, the vehicle comprises a single seating means for a driver.

According to one embodiment of the invention, the vehicle 1 comprises at least three wheels. According to one embodiment of the invention, the mobility vehicle 1 comprises four wheels 10, 10′, 11, 11′.

Two wheels 11, 11′ are positioned at the front of the vehicle and two wheels 10, 10′ are positioned at the rear of the vehicle.

The vehicle 1 comprises at least a brake pedal and a throttle pedal 30.

According to one embodiment of the invention, the vehicle is equipped with a brake contact switch 32.

According to one embodiment of the invention, the vehicle is equipped with a position sensor 60 for the position of the handbrake 61 in order to determine whether or not the handbrake is on. This allows the user to be alerted.

According to one embodiment of the invention, the vehicle 1 is equipped with an emergency stop means 70. According to one embodiment of the invention, the means 70 is a button that the user can activate if there is a problem while driving.

According to one embodiment of the invention, the throttle pedal 30 is equipped with a sensor 31 of the potentiometer type. This pedal sensor 31 transmits the throttle position to the motor computer. This data allows the wishes of the user to be applied immediately.

All of the mobility-vehicle data are displayed via a display screen 50 situated on the instrument panel.

According to a first alternative embodiment [FIG. 1], the two rear wheels 10, 10′ are independent. What that means is that they are not physically connected.

They therefore operate independently of one another. According to this first alternative, each electric machine 21, 21′ operates one rear wheel 10, 10′ each, independently.

According to a second alternative embodiment [FIG. 2], the two rear wheels 10, 10′ are dependent. They are physically, which is to say mechanically, connected.

According to one embodiment, the two rear wheels 10, 10′ are connected by a transmission shaft 100. According to one embodiment of this second alternative, the two machines 21, 21′ of the propulsion system operate identically. The two wheels are operated the same way.

The mobility vehicle thus comprises a control means enabling selection of the mode of operation of the vehicle.

A first mode of operation consists in keeping the two wheels physically independent and in operating them independently. For example, by disconnecting the transmission shaft 100 from the wheels.

A second mode of operation consists in physically connecting the two wheels and of operating them jointly. What that means is that they receive the same torque.

The invention also relates to the method for operating a mobility vehicle according to the invention, comprising:
A mode of operation in which the two rear wheels 10, 10′ operate independently,
A mode of operation in which the two rear wheels 10, 10′ operate dependently.

According to one embodiment of the invention, the mobility vehicle is a cross car.

The scope of the present invention is not limited to the details given above and allows embodiments in numerous other specific forms without moving away from the field of application of the invention. Consequently, the present embodiments should be considered to be by way of illustration, and can be modified without, however, departing from the scope defined by the claims.

1. A rear-wheel drive propulsion system for a mobility vehicle,
the propulsion system comprising at least two electric machines and two transmission devices,
wherein each machine is associated with one transmission device and operates independently of one another.

2. The rear-wheel drive propulsion system as claimed in claim 1, wherein the power of each of the electric machines is equal to 25 kW.

3. The rear-wheel drive propulsion system as claimed in claim 1, wherein the electric machine is a 48 V machine.

4. The rear-wheel drive propulsion system as claimed in claim 1,
wherein the transmission device comprises a reduction stage comprising a ribbed elastic belt and two pulleys.

5. The rear-wheel drive propulsion system as claimed in claim 1, comprising a 48 V/12 V (DC/DC) voltage converter.

6. The rear-wheel drive propulsion system as claimed in claim 1,
comprising a motor control unit which controls all of the electrical and electronic elements of the mobility vehicle.

7. The use of the propulsion system as claimed in claim 1 in a mobility vehicle comprising at least 3 wheels.

8. A mobility vehicle comprising a propulsion system as claimed in claim 1.

9. The mobility vehicle as claimed in claim 8,
wherein a first electric machine operates a first rear wheel and a second electric machine operates a second rear wheel.

10. A cross car equipped with a propulsion system as claimed in claim 1.
